(19) United States
(12) Patent Application Publication
(10) Pub. No.: US 2010/0267000 A1
(43) Pub. Date: Oct. 21, 2010

(54) Computer systems and method for educational use

(75) Inventor: Douglas A. Crouch, Charlotte, NC (US)

Correspondence Address: Schwartz Law Firm, P.C.;SouthPark Towers, Suite 1135, 6100 Fairview Road, Charlotte, NC, 28210, US

(73) Assignee: Manchester Sky, LLC

(21) Appl. No.: 12/803,256

(22) Filed: Jun. 22, 2010

Related U.S. Application Data
(63) Continuation of application No. 11/765,877, filed on Jun. 20, 2007, now abandoned.

(51) Int. Cl. G09B 5/00

(52) U.S. Cl. 434/350

(57) ABSTRACT

The present disclosure provides a computer system and associated usage method solely for educational purposes. The computer system is a computer appliance focused solely for educational use operating only educationally approved programs and loading only educationally approved content. Advantageously, such appliance provides a secure and focused platform for learning that can be used at home by parents and students and in class by teachers, parents, and students.

### FIELD OF THE DISCLOSURE

The present disclosure relates generally to computers. More specifically, the present disclosure provides a computer system and associated usage method solely for educational use.

### BACKGROUND OF THE DISCLOSURE

Desktop and laptop computers have proliferated as technology has advanced and costs have decreased. At present, a desktop or laptop computer can be purchased for well under $1000. Further, network connectivity has also proliferated allowing computers to connection to local area networks (LANs), wide area networks (WANs), the Internet, and the like through both wireless and wireline connections. Such network connectivity allows computer users to share information and to access the vast amount of information provided for on the Internet, such as through the World Wide Web (WWW).

With these advances, desktop and laptop computers have become an integral part of modern life. With regards to education, students, such as grade school, middle school, high school, and college students, are utilizing computers in their educational pursuits. For example, laptop computers are evolving to take over the functionality of spiral notebooks and blue books, allowing students to take notes, store papers, take tests, and the like. Also, universities and school districts are suggesting or even mandating computer ownership for all students. Computers provide similar efficiency benefits to education as they have in business.

However, the advances in network connectivity and computer performance/cost pose challenges in the educational setting. The vast amount of information available on the Internet has its advantages and disadvantages. For example, it is difficult to filter inappropriate content for younger children, inherent security flaws make it easy for hackers to gain system access, and the like. Further, many universities and schools are finding laptop usage in class a distraction because students “surf the web” and exchange email or instant messages instead of paying attention in class. As such, some schools have limited in-class computer usage. At home, computers often are more a distraction for students than an educational tool. For example, students often utilize computers to play games, browse the Web, instant message friends, and the like, rather than focusing on educational progress.

Today's students often know more about computers than their parents and teachers. This makes conventional tools ineffective to limit content or usage of computers because students often are able to disable such means. Further, computers lack means for parents and teachers to track usage and progress of students particularly with respect to education.

### BRIEF SUMMARY OF THE DISCLOSURE

In various exemplary embodiments, the present disclosure provides a computer system and associated usage method solely for educational purposes. The computer system is a computer appliance focused solely for educational use operating only educationally approved programs and loading only educationally approved content. For example, the appliance can include a desktop computer, a notebook computer, a cell phone, a personal digital assistant (PDA), and the like. Advantageously, such appliance provides a secure and focused platform for learning that can be used at home by parents and students and in class by teachers, parents, and students.

In an exemplary embodiment of the present disclosure, an educational appliance includes a data store configured to store data associated with the educational appliance, input and output interfaces, a processor connected to the data store and the input and output interfaces, and a network interface card connected to the processor, data store, and the input and output interfaces, wherein the network interface card is connected to a network. The processor is configured to operate only educationally approved applications, load educationally approved content, track progress of a student user, and implement security. The educational appliance is configured to communicate to one or more servers and base stations through the network, and the one or more servers and base stations are configured to receive progress of the student user, and designate educationally approved applications and content. The security includes protection against Denial-of-Service attacks, worms, viruses, malware, spyware, and combinations thereof; login authentication including one or more user access levels, wherein one of the one or more user access levels including a student user with limited administrative functionality; and content verification including a determination that content is approved as educational. The educational appliance further includes a smart card reader, wherein a smart card is required for login authentication at any access level other than the student user. The one or more servers and base stations are further configured to disable the network interface card at one of a user request and a predetermined time period and limit content at one of a user request and a predetermined time period. Also, the one or more servers and base stations are further configured to perform user management to create users, change user profiles, delete users, and combinations thereof on the educational appliance; perform reporting including progress reports, content history, accomplished tasks, and combinations thereof; and add the educational appliance to a class roster. Additionally, the one or more servers and base stations are further configured to distribute assignments, track completion of assignments, enable and disable network access, and remotely monitor the educational appliance. Optionally, the educational appliance is a closed appliance, and the one or more servers are configured to provide updates to the educational appliance, the updates including operating system updates, firmware updates, educationally approved application updates, new educationally approved applications, approved educational content, and combinations thereof. The input and output interfaces include a keyboard, and the keyboard includes one of on/off button, a maintenance button, an EDU home button, function keys, application keys, input keys, and combinations thereof. Optionally, the educational appliance includes one of a laptop computer and a desktop computer, the network interface card includes an Ethernet card, and one or more educationally approved peripherals can communicate with the educational appliance. Alternatively, the educational appliance includes a cell phone, the network includes a cell phone network, and the network interface card includes an antenna configured to communicate over the cell phone network. Optionally, the educational appliance includes a personal digital assistant, and the network interface card includes an antenna configured to communicate over one of a cell phone network, a wireless local area network, and a Bluetooth network. Alternatively, the educational appliance further includes a remote hard drive connected to the educational appliance to provide updates when the network interface card is unable to connect to the network, and the updates include operating system updates, firmware updates, approved educational application updates, new approved educational applications, approved educational content, and combinations thereof.

In another exemplary embodiment of the present disclosure, a classroom environment configured with multiple computer systems includes a plurality of education computer systems connected to a network, wherein the education computer systems are configured to only operate approved educational software applications and load only approved educational content; and a teacher base station computer system connected to the plurality of education computer systems through the network, wherein the teacher base station is configured to monitor and control the plurality of education computer systems. One or more of the plurality of education computer systems is remotely connected to the teacher base station through a network, and the remote connection enables a student user to participate in a class through one of a web cam, microphone, and combinations thereof. Optionally, the classroom environment configured with multiple computer systems further includes one or more servers connected to the plurality of education computer systems and the teacher base station through the network, and the one or more servers are configured to provide updates to the plurality of education computer systems and the teacher base station, the updates including operating system updates, firmware updates, approved educational application updates, new approved educational applications, approved educational content, and combinations thereof. Alternatively, the network includes a local area network without Internet access; and the classroom environment further includes a remote hard drive, and the remote hard drive includes operating system updates, firmware updates, approved educational application updates, new approved educational applications, approved educational content, and combinations thereof.

In yet another exemplary embodiment of the present disclosure, a method of using a computer system solely for educational use include powering on the computer system; checking for updates to the computer system through a network; logging into the computer system through user credentials, wherein the user credentials include one of a student user, a teacher user, a parent user, and combinations thereof; proceeding to a desktop on the computer system; operating one or more educationally approved applications, wherein the computer system is configured to only operate the one or more educationally approved applications; loading educationally approved content, wherein the computer system is configured to only load educationally approved content; if the logging into step is the student user, tracking progress of the student user; if the logging into step is one of the parent and teacher user, monitoring progress of the student user; receiving educational materials through the network; and turning in assignments through the network. Optionally, the logging into step requires a smart card for a teacher and parent user. Alternatively, the educationally approved applications and educationally approved content are provided by a server through the network. Optionally, the educationally approved applications and educationally approved content are provided by a remote hard drive.

### BRIEF DESCRIPTION OF THE DRAWINGS

The present disclosure is illustrated and described herein with reference to the various drawings, in which like reference numbers denote like system components, respectively, and in which:

FIG. 1 is a flowchart illustrating an exemplary embodiment of user authentication for an educational appliance according to the present disclosure;

FIG. 2 is a flowchart illustrating an exemplary embodiment of system start-up for an educational appliance according to the present disclosure;

FIG. 3 is a block diagram illustrating an educational appliance according to an exemplary embodiment of the present disclosure;

FIG. 4 is a diagram illustrating a first school, a second school, and a home connected through a wide area network (WAN), a router, a firewall, and the Internet, according to an exemplary embodiment of the present disclosure;

FIGS. 5a-5b are diagrams of the educational appliance of the present disclosure including a desktop computer and a notebook computer;

FIG. 6 is a rear view of the desktop computer according to an exemplary embodiment of the present disclosure;

FIG. 7 is a front view of the desktop computer according to an exemplary embodiment of the present disclosure;

FIG. 8 is a side view of the desktop computer according to an exemplary embodiment of the present disclosure;

FIG. 9 is a view of the keyboard according to an exemplary embodiment of the present disclosure;

FIG. 10 are back and front views of the notebook computer according to an exemplary embodiment of the present disclosure;

FIG. 11 are left and right side views of the notebook computer according to an exemplary embodiment of the present disclosure;

FIG. 12 is an open view of the notebook computer according to an exemplary embodiment of the present disclosure; and

FIGS. 13a and 13b are diagrams of the educational appliance of the present disclosure including a personal digital assistant and a cell phone.

### DETAILED DESCRIPTION OF THE DISCLOSURE

In various exemplary embodiments, the present disclosure provides a computer system and associated usage method solely for educational purposes. The computer system is a computer appliance focused solely for educational use operating only educationally approved programs and loading only educationally approved content. For example, the appliance can include a desktop computer, a notebook computer, a cell phone, a personal digital assistant (PDA), and the like. Advantageously, such appliance provides a secure and focused platform for learning that can be used at home by parents and students and in class by teachers, parents, and students.

As described herein, educationally approved programs and content refers to software programs and data content, such as Web sites, which is predetermined to be educational. For example, educational programs can include word processors, spreadsheets, databases, calculators, and the like. Educational content can include Web sites, such as NationalGeographic.com, Wikipedia.org, and the like. It is contemplated that this predetermination is performed by a teacher, a parent, an organization, or the like.

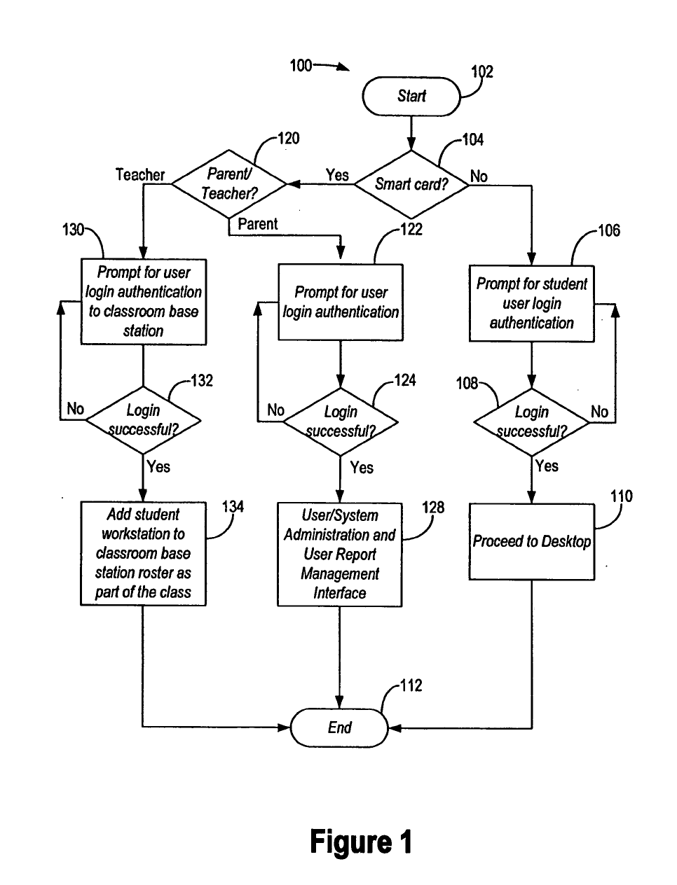

Referring to FIG. 1, a flowchart 100 illustrates an exemplary embodiment of user authentication for an educational appliance according to the present disclosure. The present disclosure provides multiple user profiles with each user profile determining system access level. For example, in one exemplary embodiment, there is a student, parent, and teacher profile. The teacher profile can provide administrative type access allowing the user to monitor multiple computer systems (i.e., students) and the like. The parent profile can provide administrative type access to one computer system allowing the user to monitor a student's progress and activity. The student profile provides user access to the computer system for various usage functions, but excludes system access from higher level functions, such as monitoring student progress, system changes, and the like, i.e. the functions provided for in the teacher and parent profiles. In other embodiments, different types of user profiles can be included.

User authentication with flowchart 100 starts (step 102). The flowchart 100 checks if a smart card is present (step 104). The smart card is a card embedded with information, such as through integrated circuits that interfaces to the educational appliance. The smart card provides an extra layer of security preventing students from authenticating with teacher or parent profiles. If the smart card is not present, then a prompt is issued for a student user login authentication (step 106). The user would input login credentials, such as a user ID and password, and the flowchart 100 checks to see if the credentials are proper leading to a successful login (step 108). If not, the flowchart 100 returns to step 106 for the user to reenter the credentials. If so, then the flowchart 100 proceeds to a desktop on the appliance (step 110), and the flowchart 100 ends (step 112).

If a smart card is present (step 104), then the flowchart 100 checks the smart card to determine if the user is a parent or teacher (step 120). If it determines the user is a parent, then a prompt is issued for a parent user login authentication (step 124). The user would input login credentials, such as a user ID and password, and the flowchart 100 checks to see if the credentials are proper leading to a successful login (step 124). If not, the flowchart 100 returns to step 122 for the user to reenter the credentials. If so, then the flowchart 100 proceeds to a user/system administrator and user report management interface on the appliance (step 128), and the flowchart 100 ends (step 112). In an exemplary embodiment of the present disclosure, the user/system administrator and user report management interface provides a parent user the ability to track a student user's progress and activity, and to set various administrator configurations.

If in step 104, the flowchart 100 determines the user is a teacher, then a prompt is issued for a teacher user login authentication (step 130). The user would input login credentials, such as a user ID and password, and the flowchart 100 checks to see if the credentials are proper leading to a successful login (step 132). If not, the flowchart 100 returns to step 132 for the user to reenter the credentials. If so, then the flowchart 100 proceeds to an interface on the appliance to add the student workstation to a classroom base station roster as part of the class (step 132), and the flowchart 100 ends (step 112). In an exemplary embodiment of the present disclosure, the roster add interface allows the teacher to include the workstation as part of the class. For example, this can allow the workstation to receive teaching materials from the teacher and the like.

Once flowchart 100 is completed the smart card can be removed and then only used again when the parent/teacher needs to add or manage users, change network settings, or check child progress. Advantageously, the smart card adds an extra layer of security to prevent students from modifying system settings and the like. Additionally, when a student logs in, they can be given an opportunity to go through a brief tutorial to familiarize themselves with the environment. Once a student logs in, the system begins to track the student's progress and activities, such as amount of time logged in, content viewed, applications used, documents produced, and the like.

The student user type can have multiple users which are housed locally and are setup by the parent user login. Once the student account is created the computer requires a username and password for authentication. This can aid in tracking individual users' progress. The parent user type requires a smart card plus a username and password to authenticate. This only gives functionality to create and manage local users, setup and change network connections, check or print progress reports, and if apart of a classroom base station the parent can also check assigned and completed work from the teacher. This deters the parent from logging in for the student. The teacher user type also requires a smart card plus a username and password to authenticate. This only gives functionality to create and manage local users, setup and change network connections, check or print progress reports, and add the workstation to the class roster on the base station for further management during class. This deters the teacher from logging in for the student.

In an exemplary embodiment, the parent user environment is configured for user management, network connection management, and reporting. The user management includes creating/deleting users and changing user profiles. The network connection management allows the parent to change the network configuration. The reporting provides progress reports (e.g., displayed and/or printed), tracking usage (e.g., Internet time, assignment time), and tasks accomplished.

The teacher user environment is configured for user management, network configuration management, reporting, and classroom administration. The user management includes creating/deleting users and changing user profiles. The network connection management allows the parent to change the network configuration. The reporting provides progress reports (e.g., displayed and/or printed), tracking usage (e.g., Internet time, assignment time), and tasks accomplished. The classroom administration allows a teacher to add educational appliances to a class roster on a teacher base station.

For example, a teacher base station can include an educational appliance or another computer configured with teacher base station software. From the base station, the teacher can manage, monitor, and administer all appliances connected to the base stations roster. This can include distribution of homework and classroom assignments, tracking completion of homework and classroom assignments, denying or allowing access to the interne, ability to remotely display any student or teachers screen within the classroom for the purpose of instruction, ability to remotely monitor any student screen within the classroom for the purpose of assurance that the student is on task, and the like. For example, a teacher can utilize the base station to turn off Internet connectivity to all appliances during class. Additionally, students can participate in the classroom remotely, such as from another school or from home via IP tunneling.

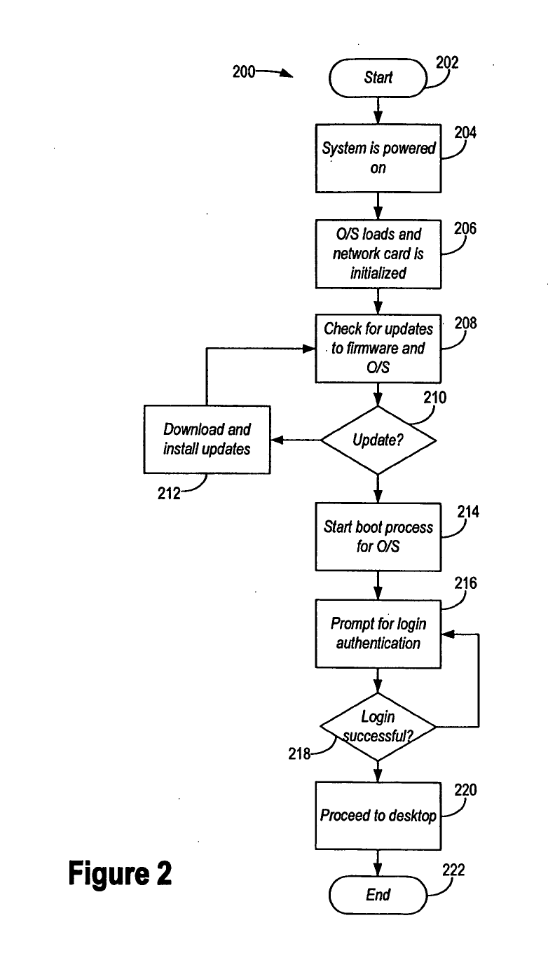

Referring to FIG. 2, a flowchart 200 illustrates an exemplary embodiment of system start-up for an educational appliance according to the present disclosure. The flowchart starts (step 202). The system is powered on (step 204). For example, the educational appliance can include a power button or the like, and a user can physically turn the appliance on. The operating system (O/S) loads and a network card is initialized (step 206). The O/S essentially controls the execution of other computer programs, and provides scheduling, input-output control, file and data management, memory management, and communication control and related services. In an exemplary embodiment of the present disclosure, the O/S is a closed system, allowing programs to only be added or modified by parent/teacher users. The network card essentially provides a communication interface from the appliance to other computers, servers, appliances, and the like through a network.

The flowchart 200 checks for updates to firmware and the O/S (step 208). In an exemplary embodiment, the appliance connects to an educational server through the network card to receive updates. The educational server provides a distribution point for updates of firmware and the O/S and can include a teacher's workstation or a remote server located on a network. If updates are required (step 210), then the updates are downloaded and installed (step 212). If not (step 210), then the boot process is started for the O/S (step 214).

Following the boot process, there is a prompt for login authentication, such as shown in the exemplary embodiment of FIG. 1 (step 216). The user would input login credentials, such as a user ID and password, and the flowchart 200 checks to see if the credentials are proper leading to a successful login (step 218). If not, the flowchart 200 returns to step 216 for the user to reenter the credentials. If so, then the flowchart 200 proceeds to the desktop (step 220), and the flowchart 200 ends (step 222). At the desktop, the user, e.g. student/teacher/parent, can access various functions on the appliance.

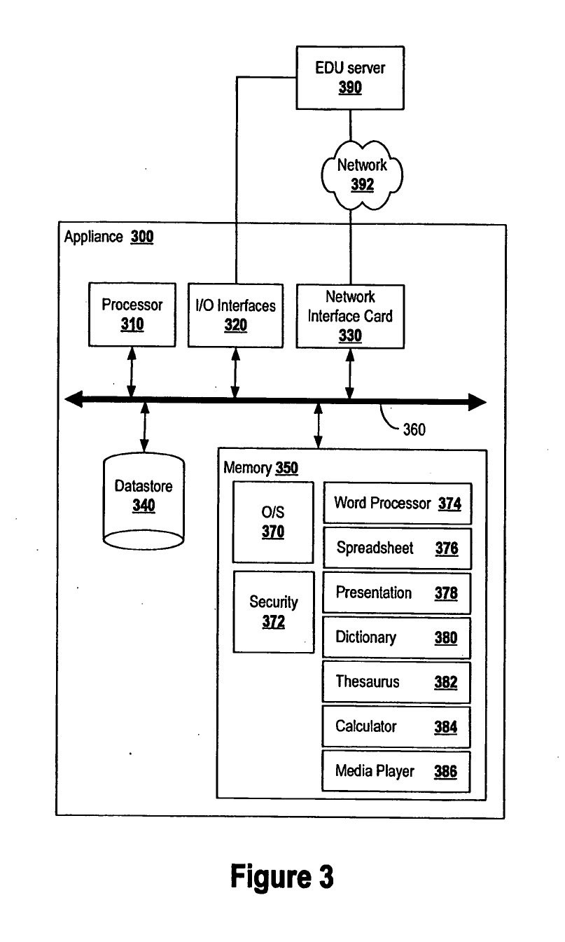

Referring to FIG. 3, a block diagram illustrates an educational appliance 300 according to an exemplary embodiment of the present disclosure. The server 300 can be a digital computer that, in terms of hardware architecture, generally includes a processor 310, input/output (I/O) interfaces 320, a network interface card 330, a data store 340, and memory 350. The components (310, 320, 330, 340, and 360) are communicatively coupled via a local interface 360. The local interface 360 can be, for example but not limited to, one or more buses or other wired or wireless connections, as is known in the art. The local interface 360 can have additional elements, which are omitted for simplicity, such as controllers, buffers (caches), drivers, repeaters, and receivers, among many others, to enable communications. Further, the local interface 360 can include address, control, and/or data connections to enable appropriate communications among the aforementioned components.

The processor 310 is a hardware device for executing software instructions. The processor 310 can be any custom made or commercially available processor, a central processing unit (CPU), an auxiliary processor among several processors associated with the appliance 300, a semiconductor-based microprocessor (in the form of a microchip or chip set), or generally any device for executing software instructions. When the appliance 300 is in operation, the processor 310 is configured to execute software stored within the memory 350, to communicate data to and from the memory 350 and data store 340, and to generally control operations of the appliance 300 pursuant to the software instructions.

The I/O interfaces 320 can be used to receive user input from and/or for providing system output to one or more devices or components. User input can be provided via, for example, a keyboard and/or a mouse. System output can be provided via a display device, i.e. monitor, and a printer (not shown). I/O interfaces 320 can include, for example, a serial port, a parallel port, a small computer system interface (SCSI), an infrared (IR) interface, a radio frequency (RF) interface, and/or a universal serial bus (USB) interface.

The network interface card 330 can be used to enable the appliance 300 to communicate on a network, such as a local area network (LAN), wide area network (WAN), the Internet, and the like. The network interface card 330 can include, for example, an Ethernet card (e.g., 10BaseT, Fast Ethernet, Gigabit Ethernet) or a wireless local area network (WLAN) card (e.g., 802.11a/b/g). The network interface card 330 can include address, control, and/or data connections to enable appropriate communications on the network.

The data store 340 can be used store data for future use by the processor 310 and memory 350. The data store can include any of volatile memory elements (e.g., random access memory (RAM, such as DRAM, SRAM, SDRAM, etc)), nonvolatile memory elements (e.g., ROM, hard drive, tape, CDROM, etc.), and combinations thereof. Moreover, the data store may incorporate electronic, magnetic, optical, and/or other types of storage media. In one example, the data store 340 can be located internal to the appliance 300 such as, for example, an internal hard drive connected to the local interface 360. Additionally, one or more additional data stores can be located external to the appliance 300 such as, for example, an external hard drive connected to the I/O interfaces 320 (e.g., SCSI or USB connection), a network attached file server, and the like.

The memory 350 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 350 may incorporate electronic, magnetic, optical, and/or other types of storage media. Note that the memory 350 can have a distributed architecture, where various components are situated remotely from one another, but can be accessed by the processor 310.

The software in memory 350 can include one or more software programs, each of which includes an ordered listing of executable instructions for implementing logical functions. In an exemplary embodiment, the software in the memory system 350 includes a suitable operating system (O/S) 370 and security program 372. The operating system 350 essentially controls the execution of other computer programs, and provides scheduling, input-output control, file and data management, memory management, and communication control and related services. The operating system 350 can be any of Windows NT, Windows 2000, Windows XP, Windows Vista (all available from Microsoft, Corp. of Redmond, Wash.), Solaris (available from Sun Microsystems, Inc. of Palo Alto, Calif.), LINUX (or another UNIX variant) (such as available from RedHat of Raleigh, N.C.), or a custom educational-only based O/S.

In a preferred embodiment of the present invention, the O/S 370 is a closed system meaning only users with administrative privileges, e.g. teachers/parents, can modify the appliance 300 settings, add/remove programs, and the like. Additionally, the O/S 370 can be configured to track progress, monitor content, and the like of a student user. This allows parents and/or teachers to monitor activity and track progress. Advantageously, this feature can be integrated with the O/S 370, preventing a student from disabling or figuring out a work-around to circumvent such features. Further, because the O/S 370 is closed, students utilize the appliance solely for approved educational uses.

The security program 372 is configured to prevent intrusion to the appliance 300 as well as ensure proper authentication of users. The security program 372 works in combination with the O/S 370, and can either be a stand-alone program or a program integrated with the O/S 370. The security program 372 provides authentication of login credentials, smart card authentication, Secure Socket Layer (SSL) certificate services authentication, and the like. Additionally, the security program 372 provides functionality to ensure the appliance is utilized solely for educational purposes as described further herein. For example, the program 372 prevents booting from external devices, accessing of other user's files, accessing O/S 370 system files and configurations (unless the user is authorized), preventing users from accessing non-educational content, and the like.

Additionally, the security program 372 provides protection and access limitations with regards to the network card 330. This can include preventing web-site access to any site not educational. For example, web-sites can include certification means through SSL Certificate validation, through a certification process based on an internal firewall, through Internet Protocol (IP) ports on a system that are not certified, and the like. Additionally, the program 372 can provide protection against Denial-of-Service (DOS) attacks, worms, viruses, malware, spyware, or other malicious network attacks. This can be accomplished through only accepting connections to open a local IP port from sites that are certified. Also, the program 372 can perform port stealthing to further hide the system from remote IP port scans from systems looking for an open port to exploit, and this can run on both IPv4 and IPv6. Additionally, the program 372 can support a Virtual Private Network (VPN) connection, such as to an Educational (EDU) server 390 or the like. Finally, the security program 372 can provide wireless encryption on a wireless network card, such as Wired Equivalency Protection (WEP) and Wireless Protected Access (WPA).

The memory 370 also includes a plurality of software programs, such as, for example, a word processor 374, a spreadsheet editor 376, a presentation editor 378, a dictionary 380, a thesaurus 382, a calculator 384, a media player 386, and the like. These programs can be accessed through function keys on a keyboard, or through selecting an icon on the desktop with a mouse. The word processor 374 is a program configured for document creation, viewing, printing, and the like. The spreadsheet editor 376 is a table (or grid) of information allowing complex mathematical, scientific, financial, and the like calculations, comparisons, analysis, and the like. The presentation editor 378 is a program configured to create presentations, desktop publishing, and the like. Additionally, the memory 370 can include a web browser configured to operate with the security program 372 to ensure only educational content is view. Those of ordinary skill in the art will recognize the present disclosure contemplates any type of computer program.

Additionally, the appliance 300 can connection to the EDU server 390 for O/S 370 updates, appliance firmware updates, security program 372 updates, new programs, and the like. The EDU server 390 is configured to provide educationally approved applications. The EDU server 390 can connect to the appliance through a network 392, such as the Internet or a LAN, through the network interface card 330 or through a local connection through the I/O interfaces 320. Additionally, the EDU server 390 can provide the appliance 300 with approved web-sites for educational use, such as Wikipedia, Google Earth, and the like. The EDU server 390 can be remote from the appliance 300, and can support multiple appliances 300.

In another exemplary embodiment, the appliance 300 can connect to a remote hard drive in lieu of the EDU server 390. This embodiment can be utilized where Internet access is unavailable, such as in remote locations. The remote hard drive includes educationally approved applications and content, and is configured to connect to a teacher's base station or a plurality of appliances 300. For example, the remote hard drive can connect to the appliance 300 either through the I/O interfaces 320 or the network interface 330. In another example, the remote hard drive can connect to the teacher's base station, which in turn connects to the plurality of appliances 300, i.e. appliances 300 on the class roll. It is contemplated that the remote hard drive can be pre-loaded with educational content, e.g. encyclopedias, educational web content, and the like, and educational applications. Additionally, the remote hard drive can be periodically updated when network access is available or through manual upgrades (e.g., CD-ROM, DVD, etc.).

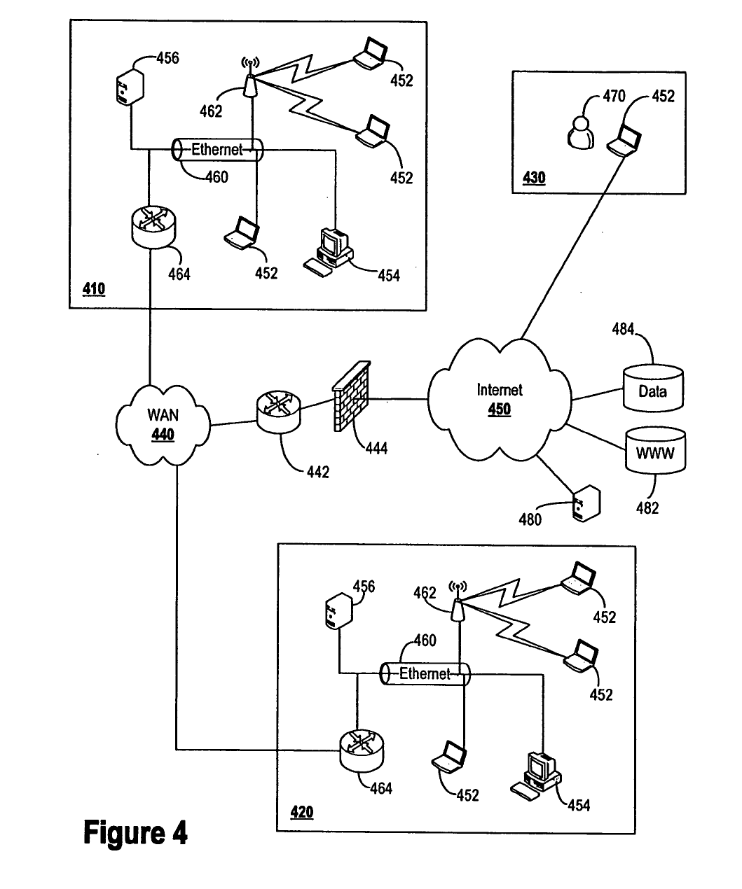

Referring to FIG. 4, a diagram illustrates a first school 410, a second school 420, and a home 430 connected through a wide area network (WAN) 440, a router 442, a firewall 444, and the Internet 450, according to an exemplary embodiment of the present disclosure. The first and second schools 410 and 420 each include multiple notebooks 452, multiple desktops 454, one or more base stations 456, an Ethernet 460 local area network (LAN), and a wireless LAN (WLAN) access point (AP) 462. Additionally, the first and second schools 410 and 420 can include a router/switch 464 connected to the WAN 440 for external communications.

In an exemplary embodiment, the notebooks 452 and desktops 454 are the educational appliances described herein. The base station 456 can maintain a class roster of each of the notebooks 452 and desktops 454 on the class roll. Additionally, the home 430 can include one or more notebooks 452 with a home user 470 remotely accessing the first and/or second schools 410 and 420. Here, the user 470 can remotely participate in class through the base station 456, such as through a web-cam broadcasting class and the like. The notebooks 452 and desktops 454 each include a network interface card (NIC) configured to provide access to the Ethernet 450 and/or the AP 462. The home 430 can include high-speed Internet 450 access, such as through a cable modem or digital subscriber loop (DSL), allowing the user 470 to access the schools 410 and 420 remotely.

Advantageously, computer usage, such as the notebook 452 or desktop 454, at the home 430 is safe and distraction-free for the user 470, i.e. a student. The present disclosure ensures students utilize the notebook 452 or desktop 454 solely for educational purposes. This is done through the monitoring feature allowing parents to track progress and through the security where the notebook 452 or desktop 454 can only operate educationally approved programs and view educationally approved content. Accordingly, users 470 are not browsing the web, instant messaging friends, playing games, and the like, but rather focused on educational pursuits.

The base station 456 provides a teacher the ability to control one or more of the notebooks 452 and desktops 454. For example, the teacher can disable Internet 450 access during class, the teacher can distribute notes to each user, a web-cam in the schools 410 and 420 can broadcast the class to one or more remote users, such as the user 470, and the like. Additionally, class assignments can be turned in electronically from the notebooks 452 and desktops 454 to the base station 456.

The Internet 450 includes a vast information store, such as an Educational (EDU) server 480, web sites 482, and data repositories 484. In an exemplary embodiment, the EDU server 480 provides updates for the notebooks 452, desktops 454, and base stations 456, including both O/S and firmware. Additionally, the EDU server 480 can maintain a list of secure, education-only web sites 482 and data repositories 484. Advantageously, this prevents student users from accessing indecent content, providing a secure learning environment, and from accessing distracting content unless allowed.

For example, the notebook 452 and desktop 454, through a web-browser application, can only access to educationally approved applications or websites. This can be accomplished through educationally approved sites via Secure Sockets Layer (SSL) public/private key cryptography 128-bit encryption. Upon request of a website the SSL connection obtains the SSL certificate and verifies it against a list of approved sites, such as on the EDU server 480 or base station 456. This takes place before any content is displayed to the user. Additionally, the EDU server 480 can be configured to provide new applications as required to enhance the learning experience.

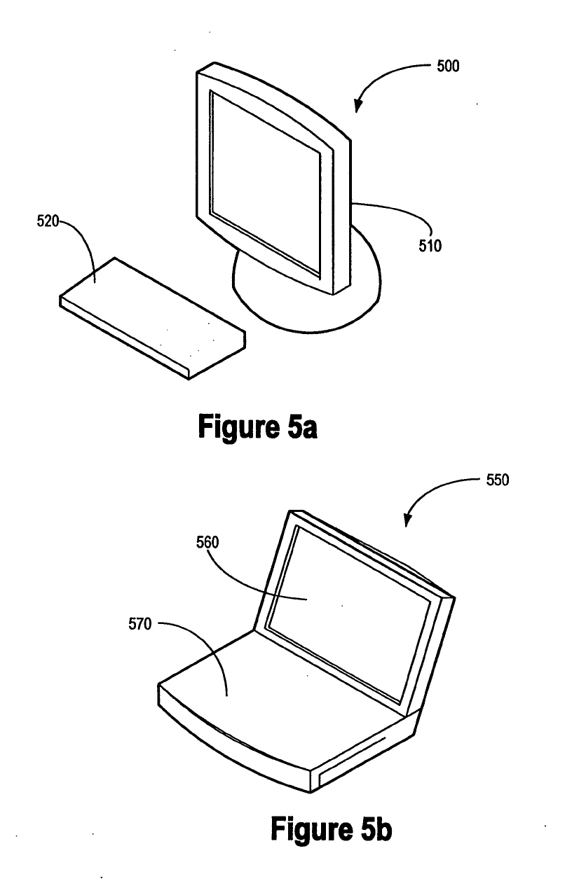

Referring to FIGS. 5a and 5b, in an exemplary embodiment, the educational appliance of the present disclosure can include a desktop computer 500 and a notebook computer 550. The desktop computer 500 includes a monitor 510 and a keyboard 520. The monitor 510 provides a display means, and in an exemplary embodiment includes the processor, hard drive, memory, I/O interfaces, and the like to provide a compact form-factor. The keyboard 520 connects to the monitor 510 allowing a user input means to the computer 500. The present disclosure contemplates additional components which are omitted for simplicity. For example, a printer, mouse, compact-disc player, and the like can be interfaced to the computer 500. Due to their nature, desktop computers 500 generally are not portable. The desktop computer 500 can be located at each student's desk and/or at a student's home.

In an exemplary embodiment, the desktop computer 500 can include 10/100/1000 Ethernet NIC, modem, USB ports, WLAN adaptor, Bluetooth interface, expandable memory slots, headphone/microphone jacks, speakers, microphone, webcam, motherboard, processor, memory, hard drive, power adaptor, smart card reader, touchpad, network maintenance key, and the like. The network maintenance key can be included on the keyboard 520 to allow a user (regardless of access level) means to troubleshoot problematic network connections. The Network Connection Maintenance button located on the keyboard is used in the case of network connectivity problems. With one push of the button the network card will reinitialize itself along with the IP network information release and renewal. It also flushes any DNS entries that are local to the workstation. Additionally, the desktop computer 500 can include educationally approved peripherals such as a compact-disc/digital video disc (CD/DVD) drive, wireless keyboard and mouse, printer, scanner, USB flash memory, external data store, digital writing tablet, and the like.

The notebook computer 550 includes a screen 560 and a keyboard 570 integrated into a single, portable form-factor. The notebook computer 550 form-factor can also include connection ports for various peripherals and connections. The notebook computer is a portable device, allowing students to take it with them. The present disclosure contemplates additional components which are omitted for simplicity. For example, a printer, mouse, compact-disc player, and the like can be interfaced to the computer 550. The notebook computer 550 can be carried by the student to each class and home after school. Further, the notebook computer 550 can operate as a digital writing tablet, allowing students to take notes for each class. Advantageously, this allows students to utilize a single appliance to replace all notebooks. Further, it is contemplated that textbooks could be distributed electronically through the EDU server described herein, allowing the notebook computer 550 to also replace physical books.

In an exemplary embodiment, the notebook computer 550 can include 10/100/1000 Ethernet NIC, modem, USB ports, WLAN adaptor, Bluetooth interface, S-video adaptor, PCMCIA card slots, expandable memory slots, headphone/microphone jacks, speakers, microphone, webcam, motherboard, processor, memory, hard drive, power adaptor, smart card reader, touchpad, network maintenance key, and the like. The network maintenance key can be included on the keyboard 520 to allow a user (regardless of access level) means to troubleshoot problematic network connections. Additionally, the notebook computer 550 can include educationally approved peripherals such as a compact-disc/digital video disc (CD/DVD) drive, wireless keyboard and mouse, printer, scanner, USB flash memory, external data store, digital writing tablet, and the like. Additionally, a base station (not shown) could have similar hardware characteristics as both the desktop and notebook computers 500 and 550. The base station would differ in the software, allowing teacher functionality.

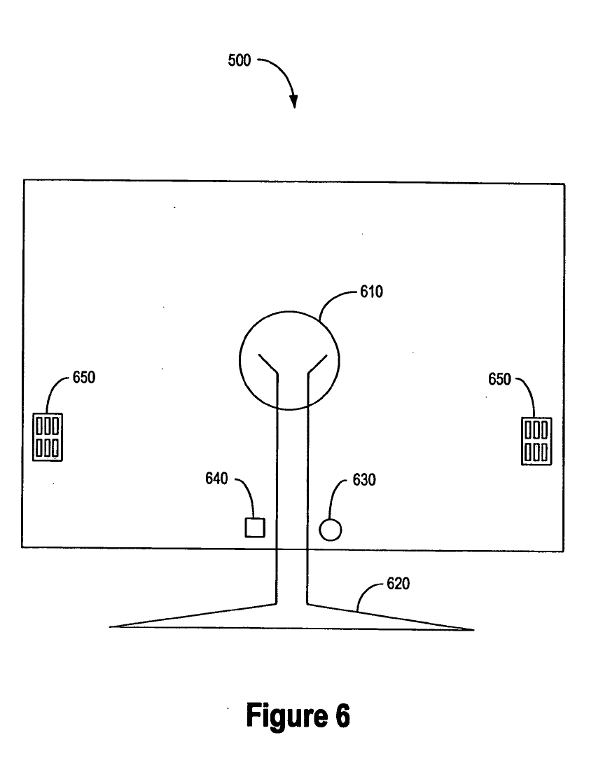

Referring to FIG. 6, a rear view of the desktop computer 500 is illustrated according to an exemplary embodiment of the present disclosure. The rear view of the desktop computer 500 includes a base stand connection 610, a base stand 620, a power port 630, an Ethernet port 640, and USB ports 650. The base stand 620 supports the desktop computer 500, and physically connects to the desktop through the connection 610. The connection 610 and base stand 620 can include adjustment means to physically change the orientation of the desktop computer 500. The power port 630 is configured to receive a power adaptor which is configured to plug into a power source, such as a wall outlet. The Ethernet port 640 can receive an Ethernet cable, such as a RJ-45 type adaptor or the like. The USB ports 650 can receive USB adaptors for various peripherals to connect to the desktop computer 500.

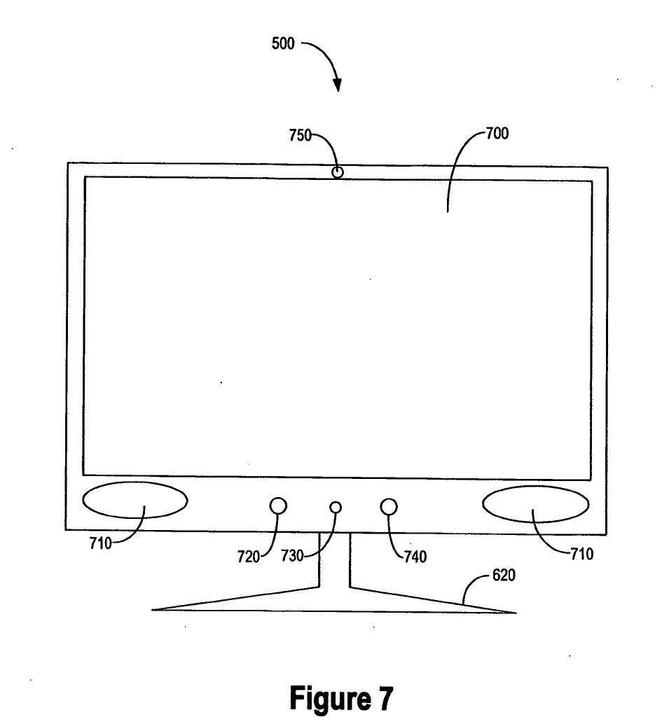

Referring to FIG. 7, a front view of the desktop computer 500 is illustrated according to an exemplary embodiment of the present disclosure. The front view of the desktop computer 500 includes a display 700, speakers 710, a monitor adjustment button 720, a microphone jack 730, a wireless enable button 740, and a web cam 750. Additionally, the base stand 620 is also illustrated. The speakers 710 are configured to play audio. The monitor adjustment button 720 is configured to change monitor settings, such as screen size, resolution, and the like. The microphone jack 730 is configured to receive a microphone cord attached to a microphone. The wireless enable button 740 provides a user the ability to turn on and off WLAN functionality. The web cam 750 provides a video recorder to transmit or store images.

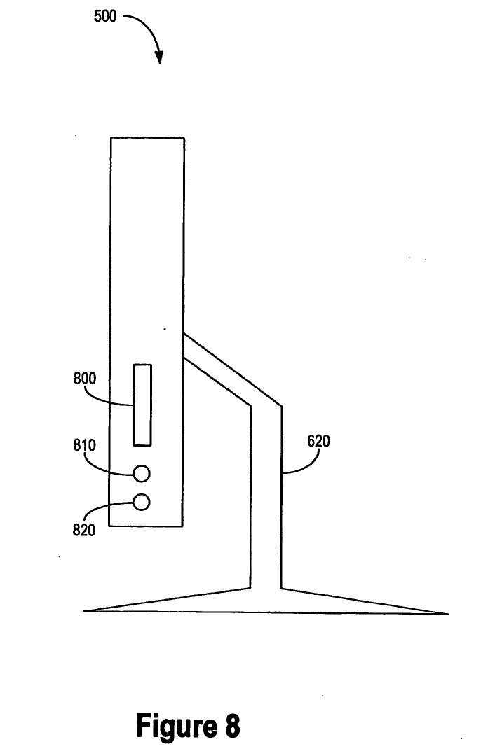

Referring to FIG. 8, a side view of the desktop computer 500 is illustrated according to an exemplary embodiment of the present disclosure. The side view of the desktop computer 500 includes a smart card reader 800, a headphone jack 810, a microphone 820, and the base stand 620. The smart card reader 800 is configured to receive smart cards from parent and/or teacher users. The headphone jack 810 is configured to receive an adaptor attached to headphones to allow a user to hear audio individually. The microphone 820 is a built-in microphone.

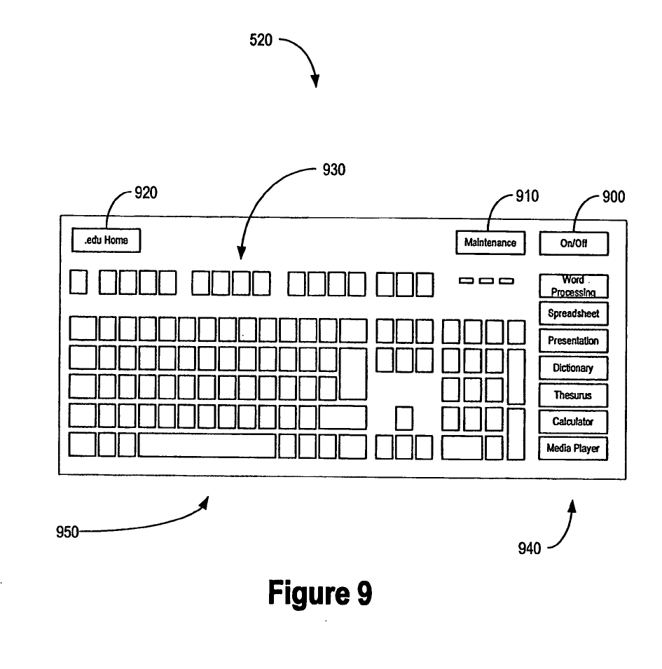

Referring to FIG. 9, the keyboard 520 is illustrated according to an exemplary embodiment of the present disclosure. The keyboard 520 can include an on/off button 900, a maintenance button 910, an EDU home button 920, function keys 930, application keys 940, and input keys 950. The input keys 950 can include QWERTY keys for the English language or any other input key type for other languages. The on/off button 900 provides a single button to turn the desktop computer 500 on and off. The maintenance button 910 can be utilized to correct problems with applications, network connections, etc. This button 910 can bring up a dialog on the monitor to assist in diagnosing and correcting problems. The EDU home button 920 provides a connection to an EDU server, such as through a web-browser. The function keys 930 can include a key for each subject matter in school, such as Music/Art, Math, Science, Social Studies, History, Health, Language, Literature, Current Events, Geography, and the like. These keys 930 can bring up dialogs associated with each subject, such as current assignments, class notes, and the like. The application keys 940 allow each education application to be launched, such as a word processor, spreadsheet, and the like. The input keys 950 provide a standard keyboard interface for a user to input data. Additionally, the present disclosure contemplates other input means, such as through a mouse, digital tablet, and the like.

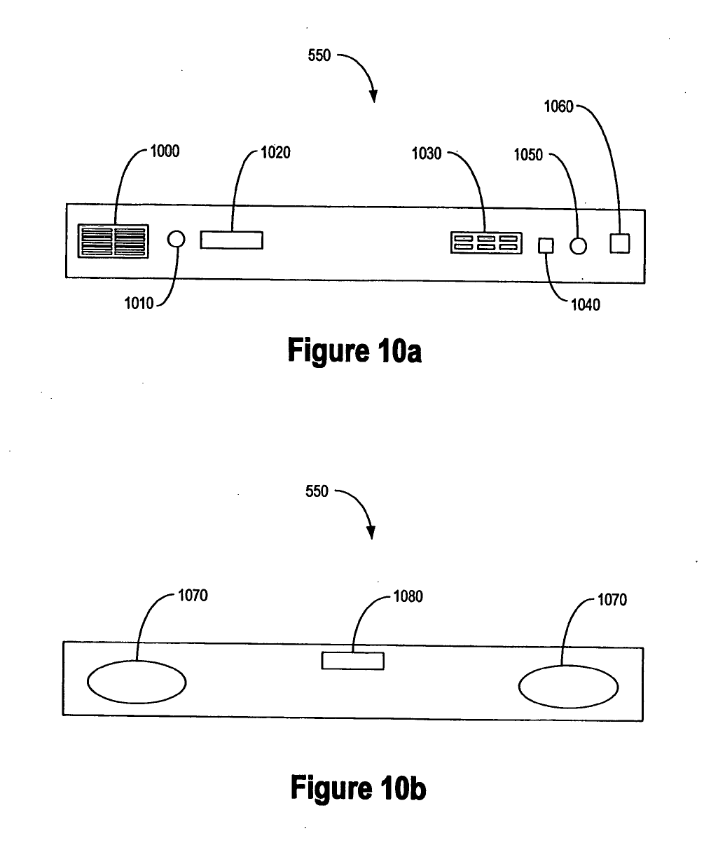

Referring to FIGS. 10a and 10b, a back and front view of the notebook computer 550 are illustrated according to an exemplary embodiment of the present disclosure. The back view of FIG. 10a can include a vent 1000, a power port 1010, a monitor port 1020, USB ports 1030, a modem port 1040, an S-Video port 1050, and an Ethernet port 1060. The vent 1000 can provide airflow for the notebook computer 550, such as through a fan or the like. The power port 1010 is configured to receive a power adaptor which is configured to plug into a power source, such as a wall outlet. The monitor port 1020 is configured to receive a monitor adaptor to connect to an external monitor. The USB ports 1030 can receive USB adaptors for various peripherals to connect to the notebook computer 550. The modem port 1040 is configured to receive an adaptor to connect to a telephone line or the like. The S-Video port 1050 is configured to receive an S-Video adaptor to connect to an external video source. The Ethernet port 1060 can receive an Ethernet cable, such as a RJ-45 type adaptor or the like. The front view of FIG. 10a can include speakers 1070 and a latch 1080. The speakers 1070 are configured to play audio. The latch 1080 is configured to open and close the notebook computer 550. For example, when closed, the latch 1080 allows a user to open the notebook computer 550.

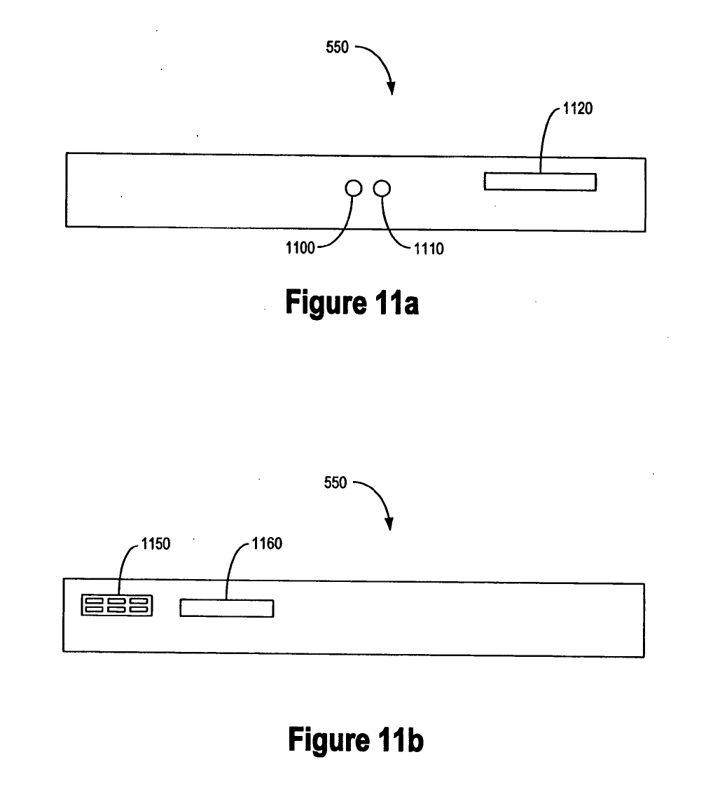

Referring to FIGS. 11a and 11b, left and right side views of the notebook computer 550 are illustrated according to an exemplary embodiment of the present disclosure. The left side view of FIG. 11a can include a microphone 1100, a headphone jack 1110, and a PCMCIA card slot 1120. The microphone 1100 is a built-in microphone. The headphone jack 1110 is configured to receive an adaptor attached to headphones to allow a user to hear audio individually. The PCMCIA card slot 1120 is configure to receive cards, such as PC cards. The right side view of FIG. 11b can include USB ports 1150 and a smart card reader 1160. The USB ports 1150 can receive USB adaptors for various peripherals to connect to the notebook computer 550. The smart card reader 1160 is configured to receive smart cards from parent and/or teacher users.

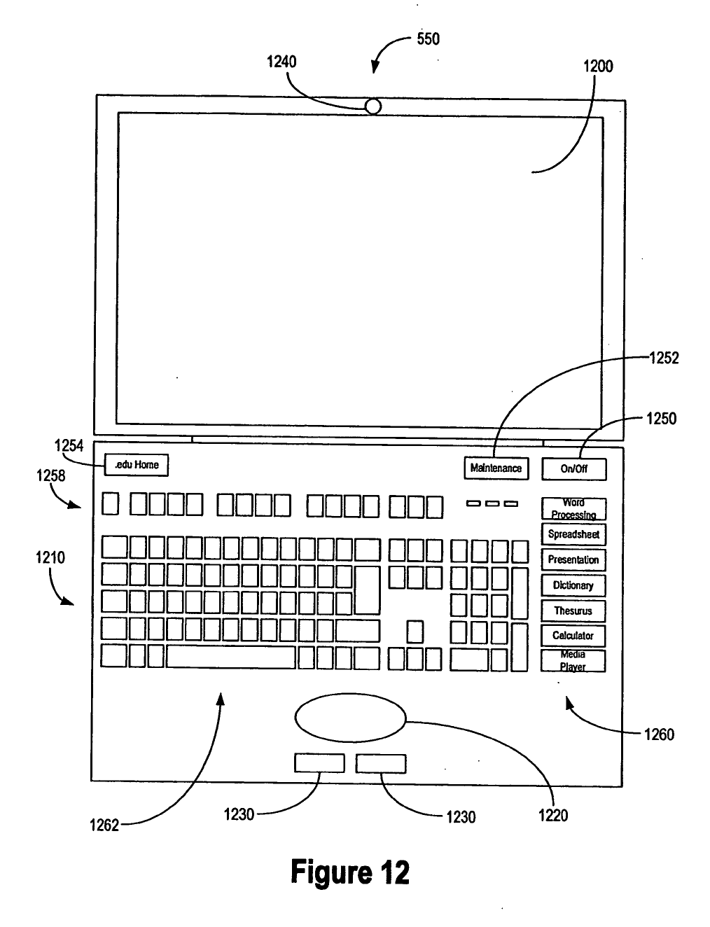

Referring to FIG. 12, an open view of the notebook computer 550 is illustrated according to an exemplary embodiment of the present disclosure. The open view of the notebook computer 550 can include a display 1200, a keyboard 1210, a touch pad 1220, touch pad buttons 1230, and a web cam 1240. The keyboard 1210 can include an on/off button 1250, a maintenance button 1252, an EDU home button 1254, function buttons 1258, application buttons 1260, and input keys 1262. The touch pad 1220 and touch pad buttons 1230 allow a user to provide input to the notebook computer 550 similar to a mouse on a desktop computer. The web cam 1240 provides a video recorder to transmit or store images.

The on/off button 1250 provides a single button to turn the network computer 550 on and off. The maintenance button 1252 can be utilized to correct problems with applications, network connections, etc. This button 1252 can bring up a dialog on the monitor to assist in diagnosing and correcting problems. The EDU home button 1254 provides a connection to an EDU server, such as through a web-browser. The function keys 1258 can include a key for each subject matter in school, such as Music/Art, Math, Science, Social Studies, History, Health, Language, Literature, Current Events, Geography, and the like. These keys 1258 can bring up dialogs associated with each subject, such as current assignments, class notes, and the like. The application keys 1260 allow each education application to be launched, such as a word processor, spreadsheet, and the like. The input keys 1262 provide a standard keyboard interface for a user to input data, such as QWERTY keys for the English language and the like. Additionally, the present disclosure contemplates other input means, such as through a mouse, digital tablet, and the like.

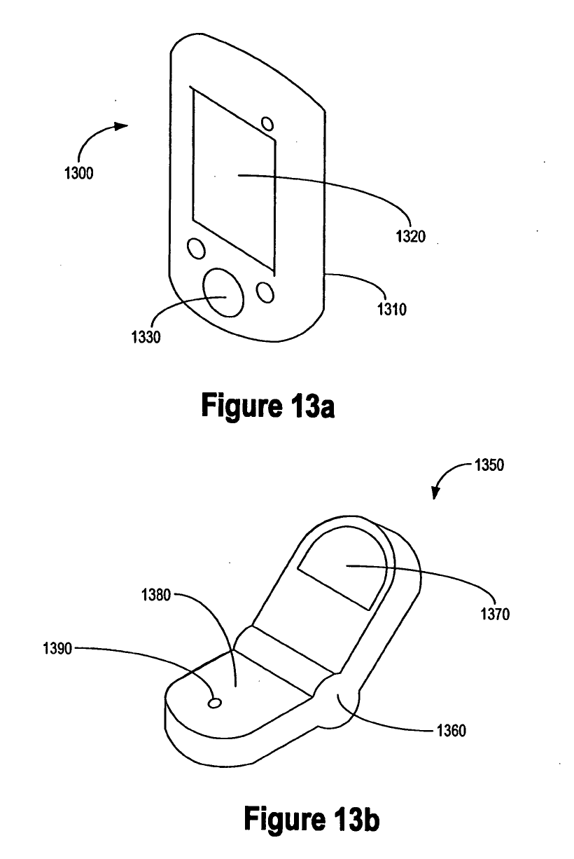

Referring to FIGS. 13a and 13b, in another exemplary embodiment, the educational appliance of the present disclosure can include a personal digital assistant (PDA) 1300 and a cellular telephone (“cell phone”) 1350. The PDA 1300 includes a case 1310, a screen 1320, and input means 1330. The PDA 1300 can include any portable electronic device configured to operate programs and communicate on a network. For example, the PDA 1300 can include a hand-held computer, an MP3 music player, a portable game player, and the like. The screen 1320 provides a display for a user, and can include a touch screen allowing input through a touch pen and the like. The input means 1330 can include a dial, a scroll bar, a keyboard, one or more buttons, and the like. The PDA 1300 includes electronics internal to the case 1310 similar to those described herein with regards to FIG. 3. Additionally, the PDA 1300 includes a network interface (not shown), such as an antenna, Ethernet connection, Bluetooth connection, or the like. The network interface allows the PDA 1300 to communicate to a network, such as a wireless local area network, a cell phone network, and the like.

The cell phone 1350 includes a case 1360, a screen 1370, input means 1380, and a speaker/microphone 1390. The screen 1370 provides a display for a user, and can include a touch screen allowing input through a touch pen and the like. The input means 1380 can include a numeric keypad, a full keyboard, and the like. The speaker/microphone 1390 enables a user to communicate with the cell phone 1350. The cell phone 1350 includes electronics internal to the case 1360 similar to those described herein with regards to FIG. 3. Additionally, the cell phone 1350 includes a network interface (not shown), such as an antenna. The network interface allows the cell phone 1350 to communicate wirelessly to one or more cell locations, enabling network access to a cell phone network.

In an exemplary embodiment, the PDA 1300 and cell phone 1350 are closed appliances only operating approved educational applications and loading approved educational content. For example, the EDU server described herein can communicate to the PDA 1300 or the cell phone 1350 through the network to designate approved content and provide approved applications. Those of ordinary skill in the art will recognize the educational-only applications and content can be operated on any multi-media platform, allowing parents and teachers the ability to monitor and control a student's usage of such platforms. Advantageously, the present disclosure focuses such platforms for education, removing the distractions and vulnerabilities associated with current open systems which allow unrestricted content and applications to be utilized.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. An educational appliance, comprising:
a data store configured to store data associated with the educational appliance;
input and output interfaces;
a processor connected to the data store and the input and output interfaces, wherein the processor is configured to:
operate only educationally approved applications;
load educationally approved content;
track progress of a student user; and
implement security;
a network interface card connected to the processor, data store, and the input and output interfaces, wherein the network interface card is connected to a network;
wherein the educational appliance is configured to communicate to one or more servers and base stations through the network, and wherein the one or more servers and base stations are configured to:
receive progress of the student user; and
designate educationally approved applications and content.

2. The educational appliance of claim 1, wherein the security comprises:
protection against Denial-of-Service attacks, worms, viruses, malware, spyware, and combinations thereof;
login authentication comprising one or more user access levels, wherein one of the one or more user access levels comprises a student user with limited administrative functionality; and
content verification comprising a determination that content is approved as educational.

3. The educational appliance of claim 2, further comprising a smart card reader, wherein a smart, card is required for login authentication at any access level other than the student user.

4. The educational appliance of claim 1, wherein the one or more servers and base stations are further configured to:
disable the network interface card at one of a user request and a predetermined time period; and
limit content at one of a user request and a predetermined time period.

5. The educational appliance of claim 1, wherein the one or more servers and base stations are further configured to:
perform user management to create users, change user profiles, delete users, and combinations thereof on the educational appliance;
perform reporting comprising progress reports, content history, accomplished tasks, and combinations thereof; and
add the educational appliance to a class roster.

6. The educational appliance of claim 5, wherein the one or more servers and base stations are further configured to:
distribute assignments;
track completion of assignments;
enable and disable network access; and
remotely monitor the educational appliance.

7. The educational appliance of claim 1, wherein the educational appliance is a closed appliance, and
wherein the one or more servers are configured to provide updates to the educational appliance, the updates comprising operating system updates, firmware updates, educationally approved application updates, new educationally approved applications, approved educational content, and combinations thereof.

8. The educational appliance of claim 1, wherein the input and output interfaces comprise a keyboard, and
wherein the keyboard comprises one of on/off button, a maintenance button, an EDU home button, function keys, application keys, input keys, and combinations thereof.

9. The educational appliance of claim 1, wherein the educational appliance comprises one of a laptop computer and a desktop computer;
wherein the network interface card comprises an Ethernet card; and
wherein one or more educationally approved peripherals can communicate with the educational appliance.

10. The educational appliance of claim 1, wherein the educational appliance comprises a cell phone;
wherein the network comprises a cell phone network; and
wherein the network interface card comprises an antenna configured to communicate over the cell phone network.

11. The educational appliance of claim 1, wherein the educational appliance comprises a personal digital assistant; and
wherein the network interface card comprises an antenna configured to communicate over one of a cell phone network, a wireless local area network, and a Bluetooth network.

12. The educational appliance of claim 1, further comprising a remote hard drive connected to the educational appliance to provide updates when the network interface card is unable to connect to the network;
wherein the updates comprise operating system updates, firmware updates, approved educational application updates, new approved educational applications, approved educational content, and combinations thereof.

13. A classroom environment configured with multiple computer systems, comprising:
a plurality of education computer systems connected to a network, wherein the education computer systems are configured to only operate approved educational software applications and load only approved educational content; and
a teacher base station computer system connected to the plurality of education computer systems through the network, wherein the teacher base station is configured to monitor and control the plurality of education computer systems.

14. The classroom environment configured with multiple computer systems of claim 13, wherein one or more of the plurality of education computer systems is remotely connected to the teacher base station through a network, and
wherein the remote connection enables a student user to participate in a class through one of a web cam, microphone, and combinations thereof.

15. The classroom environment configured with multiple computer systems of claim 13, further comprising one or more servers connected to the plurality of education computer systems and the teacher base station through the network,
wherein the one or more servers are configured to provide updates to the plurality of education computer systems and the teacher base station, the updates comprising operating system updates, firmware updates, approved educational application updates, new approved educational applications, approved educational content, and combinations thereof.

16. The classroom environment configured with multiple computer systems of claim 13, wherein the network comprises a local area network without Internet access;
wherein the classroom environment further comprises a remote hard drive, wherein the remote hard drive comprises operating system updates, firmware updates, approved educational application updates, new approved educational applications, approved educational content, and combinations thereof.

17. A method of using a computer system solely for educational use, comprising:
powering on the computer system;
checking for updates to the computer system through a network;
logging into the computer system through user credentials, wherein the user credentials comprise one of a student user, a teacher user, a parent user, and combinations thereof;
proceeding to a desktop on the computer system;
operating one or more educationally approved applications, wherein the computer system is configured to only operate the one or more educationally approved applications;
loading educationally approved content, wherein the computer system is configured to only load educationally approved content;
if the logging into step is the student user, tracking progress of the student user;
if the logging into step is one of the parent and teacher user, monitoring progress of the student user;
receiving educational materials through the network; and
turning in assignments through the network.

18. The method of using a computer system solely for educational use of claim 17, wherein the logging into step requires a smart card for a teacher and parent user.

19. The method of using a computer system solely for educational use of claim 17, wherein the educationally approved applications and educationally approved content are provided by a server through the network.

20. The method of using a computer system solely for educational use of claim 17, wherein the educationally approved applications and educationally approved content are provided by a remote hard drive.
